(19) United States
(12) Patent Application Publication
(10) Pub. No.: US 2006/0102669 A1
(43) Pub. Date: May 18, 2006

(54) Toolbox conveyance system for a pickup truck

(76) Inventors: William L. Fouts, Henderson, NV (US); Richard D. Quinn, Henderson, NV (US)

Correspondence Address: WILLIAM L. FOUTS, 2007 CULLEN ST, HENDERSON, NV, 89015, US

(21) Appl. No.: 10/988,139

(22) Filed: Nov. 15, 2004

(51) Int. Cl. B60R 9/00

(52) U.S. Cl. 224/404; 224/510; 224/281

(57) ABSTRACT

A toolbox with carriage assemblies that have roller casters that are engaged with drop rails mounted on opposite sidewalls of a pickup truck cargo area such that the toolbox can be slid along the length of the cargo area to access its contents is provided.

### CROSS REFERENCE TO RELATED APPLICATIONS

Not Applicable

### BACKGROUND

1. Field of the Invention

This invention relates to toolbox conveyance systems for pickup trucks in general but in particular to systems that use rollers to convey the toolbox along channels, or rails, or tracks mounted on the side walls of a pickup truck cargo area.

2. Description of the Prior Art

Storage containers such as toolboxes or lockers can be used with pickup trucks to hold a variety of items including, tools, parts, or supplies. These containers are generally lockable, are made from a wide variety of materials, may have drawers or compartments, may be an open enclosure or have a top cover.

Typically, these storage containers are placed on the floor of the cargo area or, are mounted atop the sidewalls of the cargo area adjacent to the truck cab. However, storage containers that are placed on the floor of the cargo area create several problems since:
(a) the storage container can damage the painted surface of the cargo area when dragged along the surface of the floor;
(b) the storage container can damage the interior surface of the cargo area and tailgate if not properly secured and allowed to move about during the operation of the pickup truck;
(c) access to the storage container is restricted by the cargo area sidewalls and can require the user to climb on to the pick up truck to either place items into the storage container or to retrieve its contents.

Similarly, storage containers mounted atop the truck box sidewalls create several problems since:
(a) the storage container can restrict access to tie downs located within the truck cargo area;
(b) the storage container obstructs the top of the sidewall and may also cover the stake sockets in the top of the cargo area sidewalls restricting the use of tie downs, and the installation of stake bed type cab over storage racks, stake bed siding, camper shells or cargo area cover;
(c) the storage container can obscure the drivers view out of the rear window of the pickup trucks cab.

In the related art, at least one device discloses a storage box that can be rolled on and off of a pickup truck. The storage box is slidably and releasably connected to channel pieces mounted on opposite interior sidewalls of the pickup truck cargo area. Roller elements mounted to the bottom of the toolbox are then used to support and roll the storage box over the surface of the pickup truck cargo area floor. These include U.S. Pat. No. 5,924,616 issued in the name of Shives. This device however has several problems since:
(a) the cargo area floor must be clear of materials before the storage box can be rolled on or off of the pickup truck;
(b) a full storage box may be too cumbersome for one person to safely remove or place on to the truck. This may require the user to remove some or all of its contents to make its lifting and transport more manageable;
(c) a full storage box could be difficult to maneuver within the cargo area of the pickup truck, and if not substantially parallel to the sidewalls when being rolled, it may become jammed between the sides of the storage box and the channel pieces.

At least one add-on toolbox transport device for rolling a toolbox on or off of a truck bed was also disclosed. This device uses a guide track mounted on opposite interior sidewalls of the truck box, and four brackets, each bracket having a roller on one end, and a wheel on the other end. After connecting the brackets to a traditional standard tool box, the toolbox is slidably and releasably connected to the guide track by the rollers, while the wheels support the toolbox when it is rolled over the floor of the pickup truck cargo area. This includes U.S. Pat. No. 6,264,083 B1 issued in the name of Pavlick et al. However, this device also has several problems since:
(a) the floor of the truck cargo area must be clear of materials before the toolbox can be rolled on or off of the pickup truck. Having to unload the pickup truck before removing the toolbox can be time consuming;
(b) a full toolbox may be too cumbersome for one person to safely remove or install. This may require the user to remove some or all of its contents to make its lifting and transport more manageable;
(c) the toolbox when removed from the truck at a job site may become bogged down in debris, mud or other soft soils when rolled around;
(d) the toolbox extends over the top of the sidewalls and restricts operator access to the stake sockets in the top of the sidewalls for securing bulk cargo;
(e) the traditional standard toolbox would require removal from the truck if the operator desired the installation and use of a stake bed type cab over storage rack, stake bed siding, a camper shell or a cargo area cover.

At least one device for the mounting of a stowage receptacle at the tailgate area of pick up truck was disclosed. This device includes a storage receptacle with slide rails mounted on its ends. These slide rails engage guide rails that are detachably mounted at the rear of the pickup truck cargo area. In this manner the storage container can be moved out from the rear of the truck over the lowered tail gate to gain access to its contents. This includes U.S. Pat. No. 5,964,492 issued in the name of Lyon. Unlike previous related art, the Lyon device provides for added security of the device through the use of a tonneau cover and will accommodate the use of a camper shell, stake bed type cab over storage rack and stake bed siding. However, since the storage receptacle cannot be slid to the forward end of the cargo area the operator would be required to:
(a) load and unload bulk cargo up and over the storage receptacle, or from the side of the truck;
(b) climb on to the truck to load and unload bulk cargo;
(c) remove the storage receptacle from the truck to load or unload bulk cargo.

Further, the storage receptacle may be too cumbersome for one person to safely remove or install and having to remove or reinstall the device can be time consuming.

In the present art, several patents disclose a toolbox that is conveyed by rollers along channels mounted atop the sidewalls of a pick up truck box. These include U.S. Pat. No. 5,121,959 issued in the name of King, and U.S. Pat. No. 5,037,153 issued in the name of Stark. However, since these devices use rails or channels mounted on top of the sidewalls to convey the tool box, the operator:
(a) doesn't have access to the stake sockets to secure bulk cargo;
(b) would have to remove the toolbox and rails from the truck if the installation and use of a stake bed type cab over storage rack, stake bed siding, a camper shell or cargo area cover was desired. Also, these devices restrict the drivers visibility through the rear window of the pick up trucks cab.

Of particular interest in the present art are patents that disclose a toolbox with rollers on both ends that is conveyed along rails, channels, or tracks mounted on opposite interior sidewalls of the pick up truck cargo area. These devices include U.S. Pat. No. 6,015,177 issued in the name of Tijerina, U.S. Pat. No. 4,522,326 issued in the name of Tuohy III, U.S. Pat. No. 5,088,636 issued in the name of Barahas, and U.S. Pat. No. 4,635,992 issued in the name of Hamilton et al. These devices however also create several problems for the operator.

The Tijerina device was the most complex of these devices. The Tijerina device uses a mechanical means to convey a toolbox along tracks over the length of the truck cargo area on wheeled transit assemblies. The costs to market, install and maintain such a device are considered prohibitive. Also, since the tool box extends over the top of the truck cargo area sidewalls it:
(a) restricts operator access to, and use of, the stake sockets in the top of the sidewalls;
(b) would require removal of the toolbox if the installation of a stake bed type cab over storage rack, stake bed siding, a camper shell or cargo area cover was desired.

The Tuohy, Barahas and Hamilton devices do allow access to the stake sockets in the top of the sidewalls and can accommodate a stake bed type cab over storage rack, stake bed siding or a camper shell. However, improvements to each of these devices are needed since:
(a) the top of each of these storage containers extends above the top of the cargo area sidewalls restricting the use of various after market cargo covers without altering or removing the tool box;
(b) there is no locking device to secure the tool box top lid to prevent pilfering;
(c) the toolbox of the Tuohy device obscures the drivers view out of the rear window of the pickup trucks cab.

With the exception of the Tuohy device that uses a pole with a hook on one end that is placed on the channel between the toolbox and the rear tailgate of the truck to prevent movement of the toolbox along the channels, each of the Barahas and Hamilton devices lock the toolbox in various locations within the cargo area of the truck through the use of a single rod that engages apertures in the rail or channel. A single rod however may bend and become jammed in the aperture or may prove to be insufficient to restrain a heavily loaded toolbox during operation of the pickup truck. Also, alignment of the apertures in the rails or channels could be time consuming during installation and difficult to maintain in operation.

If the pole of the Tuohy device, previously discussed, becomes jammed between the toolbox and channel the operator would not be able to move the toolbox when desired. Also, if the pole is substantially bent, lost or misplaced the toolbox would have to be removed from the truck or an alternative means would have to be used to prevent movement of the toolbox in the cargo area during the trucks operation.

An additional problem for the Barahas and Hamilton devices is the location of their latch release levers. The latch release lever of the Barahas device is located near the top left corner of the storage container. This may require the operator to stand in traffic to release the storage container from its latched position or climb on to the truck if unable to reach the handle from the passenger side of the truck. Similarly, the latch release lever for the Hamilton device is located near the top center of the storage container. This may require the operator to climb on to the truck to release the storage container from its latched position if the latch release handle isn't easily reached from either side of the truck.

### SUMMARY

In accordance with the present invention a conveyance system for the movement of a toolbox within the cargo area of a pickup truck is provided including, a lockable toolbox, carriage assemblies with rollers and release arms, and drop rails mounted on opposite interior sidewalls of the pickup truck cargo area to slide the toolbox along with slide stops attached to the drop rails for latching the toolbox adjacent to the cargo area front wall or at the cargo area rear tail gate wall.

### OBJECTS AND ADVANTAGES

Accordingly, besides the advantages of the toolbox conveyance system previously summarized, several objects of our patent include, a toolbox conveyance system that is operable by one person; a toolbox conveyance system that provides an unencumbered sidewall top surface; a toolbox that does not require alteration or removal when used in conjunction with stake bed type cab over storage racks, stake bed siding, camper shells and cargo area covers; a toolbox latching mechanism that can be operated from either side of the pickup truck; a toolbox having a locking device to prevent unwanted opening of the top lid and pilferage of its contents; a toolbox that is movable within the cargo area of a pickup truck; a toolbox that doesn't require removal when loading or unloading bulk cargo; a toolbox that will not restrict the visibility of the operator through the rear window of the pick up truck cab; a toolbox conveyance system that is easy to maintain and sturdy in its construction.

Further objects and advantages will become apparent from a consideration of the ensuing description and drawings.

### DRAWING FIGURES

FIG. 1 is a perspective view showing the toolbox installed on drop rails in the cargo area of a pickup truck

FIG. 2 is a view of the left side of the toolbox installed on the sidewall of the cargo area of a pickup truck

FIG. 3 is an isometric view of the toolbox showing linkage components inside

FIGS. 3A and 3B is a left end view of the toolbox showing top lid open and closed

FIG. 4 is an exploded view of the underside of a carriage assembly for the right side of the toolbox

FIG. 5 is an isometric view of the underside of an assembled carriage assembly for the right side of the toolbox

FIG. 6 is an isometric view of the right and left carriage assemblies removed from the toolbox. showing the operation of the release arms and attached linkage

FIGS. 7A and 7B is an isometric view of the slide stops removed from a drop rail

FIGS. 7C and 7D is an isometric view of the drop rails removed from the pickup truck

FIG. 7E is a cross section view of a drop rail with a slide stop

FIGS. 8A and 8B is an end view of drop rail alternative embodiments

FIGS. 9A and 9B is an isometric view of release arm alternative embodiments

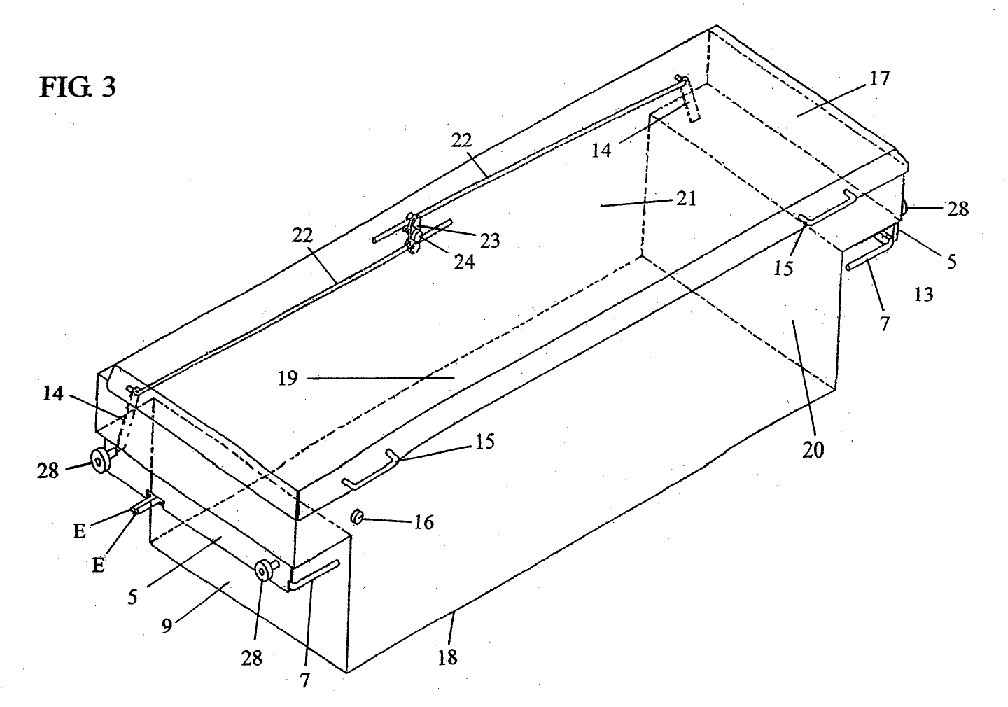

The complete toolbox 1 of the toolbox conveyance system for a pickup truck includes a left end panel, right end panel, front panel, back panel, bottom panel, top panel, handles and a locking device. When these individual components are referred to within this patent for clarity, the numerals assigned to these items will be as shown on FIG. 3.

### REFERENCE NUMERALS IN DRAWINGS

1 Toolbox (complete)
2 Drop Rail
3 Screw
4 Roller Caster
5 Carriage Assembly
6 Shaft Collar
7 Release Arm
8 Slide Stop
9 Left End Panel
10 Piano Hinge
11 Fastener
12 All Thread
13 Retainer Plate
14 Latch Arm
15 Handles
16 Locking Device
17 Top Lid
18 Front Panel
19 Bottom Panel
20 Right End Panel
21 Back Panel
22 Linkage Arm
23 Arm Connector
24 Fastener
25 Keeper
27 Fastener
28 Wheel
40 Floor
41 Sidewalls
42 Front Wall
43 Rear Tailgate Wall
44 Rear Window
45 Pickup Truck
46 Stake Sockets

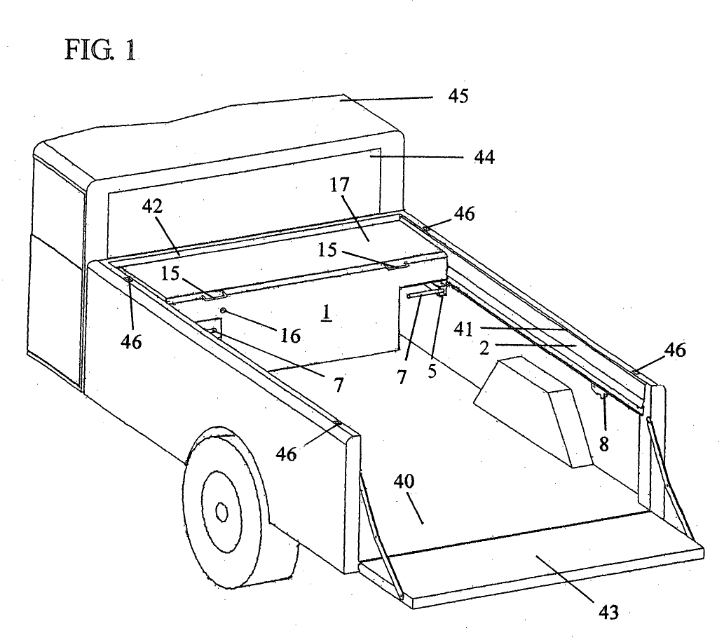

### DESCRIPTION—FIGS. 1, 2, 3, 3A, 3B, 4, 5, 6 AND 7A THROUGH 7E

### PREFERRED EMBODIMENT

FIG. 1 shows the toolbox 1 of the toolbox conveyance system for a pickup truck to advantage the cargo area of a pickup truck 45. The toolbox 1 as shown, is in its stored position adjacent to the front wall 42 of the trucks cargo area. The toolbox 1 is supported above the floor 40 by drop rails 2 that are mounted to the sidewalls 41. The release arms 7, shown with the carriage assembly 5 are accessible to release the toolbox 1 for movement along the drop rail 2 to the rear tailgate wall 43 where slide stops 8 would stop and latch the toolbox 1 to prevent its movement. At the rear tailgate wall 43 the contents of the toolbox 1 are easily accessible by releasing the locking device 16 and raising the top lid 17.

Whether the toolbox 1 is in its stored position adjacent the front wall 42 of the cargo area, or at the rear tailgate wall 43 of the cargo area, the toolbox 1 does not obscure the drivers view out of the rear window 44 of the pickup truck 45 and the stake sockets 46 in the top of the sidewalls 41 are unencumbered.

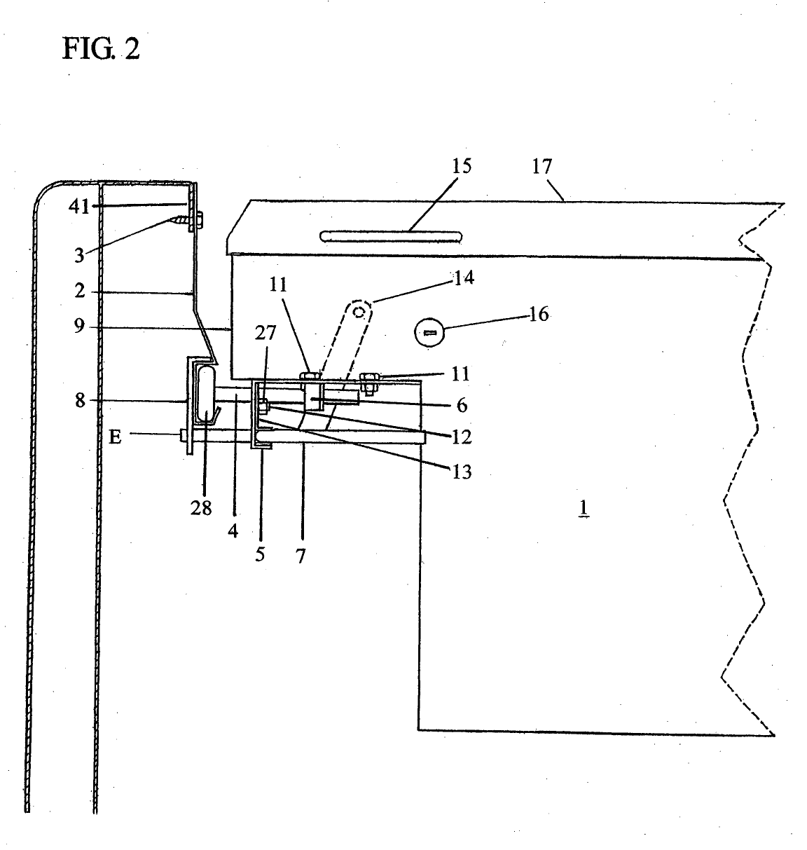

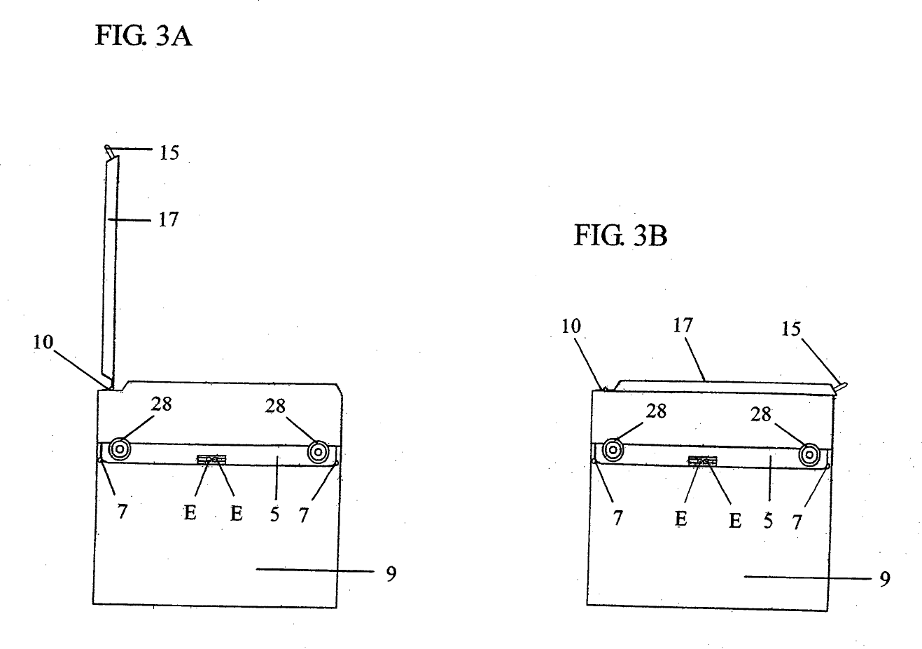

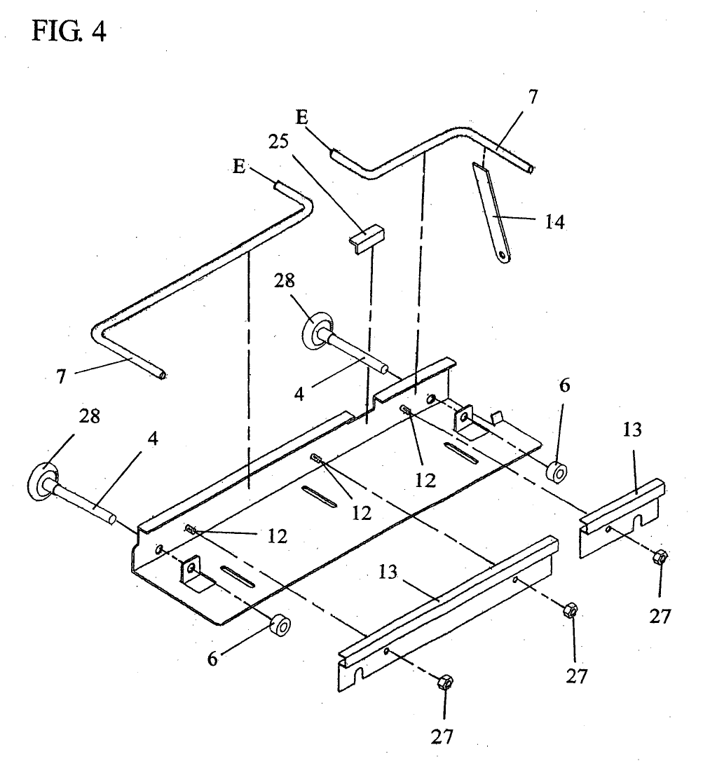

FIG. 2 displays the left side of the toolbox 1 in its installed condition. Right side not shown. As displayed, the drop rail 2 is attached to the left side sidewalls 41 of a pickup truck 45 shown on FIG. 1 by screws 3. The toolbox 1 is supported by a roller caster 4 its wheel 28 is slidably engaged with the drop rail 2. The roller casters 4 are assembled to the carriage assembly 5 and are slidably engaged with shaft collars 6. The shaft collars 6 have a set screw, not shown, to hold each roller caster 4 in place. The track area of the drop rail 2 has adequate depth and width to restrain lateral movement of the wheel 28 to prevent it from derailing. Vertical restraint of the wheel 28 is also provided by the drop rail 2 and the ends E of the release arms 7 that extend from the carriage assembly 5 to engage the slide stops 8 as shown. Further, the clearance provided around the wheel 28 by the drop rail 2 is sufficient to permit free rotation. The carriage assembly 5, is slidably attached to the left end panel 9 of the toolbox 1 using fasteners 11. The mounting holes of the carriage assembly 5 are slotted as shown on FIG. 4 and FIG. 5 to permit sideward movement and alignment of the wheels 28 to the track area of the drop rails 2 to compensate for variations in the widths of a pickup trucks 45 cargo area. The release arm 7 is shown attached to the carriage assembly 5 by a retainer plate 13 all thread 12 and fastener 27, also shown on FIGS. 4 and 5. Also shown on FIG. 2 is a latch arm 14 that is attached to the a release arm 7 a handle 15 and locking device 16 for the top lid 17 of the toolbox 1.

FIG. 3 displays the toolbox 1 removed from the pickup truck 45. It can be seen that the toolbox 1 is comprised of a left end panel 9, right end panel 20, front panel 18, back panel 21, bottom panel 19, top lid 17, handles 15, and locking device 16. Attached to the toolbox 1 are the carriage assemblies 5 shown with wheels 28 release arms 7 and the ends E of the release arms 7 that extend from the carriage assembly 5. Shown within the toolbox 1 are linkage arms 22 arm connector 23 fastener 24 and latch arms 14 As shown on FIGS. 3A and 3B, the top lid 17 is movable between a closed and open position by a piano hinge 10.

In the preferred embodiment there is one carriage assembly 5 attached to the left end panel 9 and right end panel 20 of the toolbox 1. FIG. 4 displays the parts assembled to the underside of a carriage assembly 5, right side only shown, including, release arms 7 retainer plates 13 keeper 25 shaft collars 6 all thread 12 fasteners 27 latch arms 14 roller casters 4 and the roller caster wheels 28.

The underside of a carriage assembly 5, right side only, is shown in its assembled condition in FIG. 5. It is during assembly of the carriage assembly 5 that latch arms 14 are attached to the release arms 7. Also, the release arms 7 are permanently joined by welding, thus the single release arms become a single acting pair. It is the ends E of the joined release arms 7 that extend from the carriage assembly 5 that engage the slides tops 8 attached to the drop rails 2 to prevent movement of the toolbox 1 heretofore shown on FIG. 2. As such, and since the release arms 7 are rotatably mounted to the carriage assembly 5, raising either end of the release arms 7 that are joined also causes both ends E of the release arms 7 that extend from the carriage assembly 5 and are engaged with the slide stops 8 to be lowered from their normally horizontal position. Conversely, lowering the end of either release arm 7 also causes both ends E of the release arms 7 that extend from the carriage assembly 5 and are engaged with the slide stops 8 to return to their previous horizontal position.

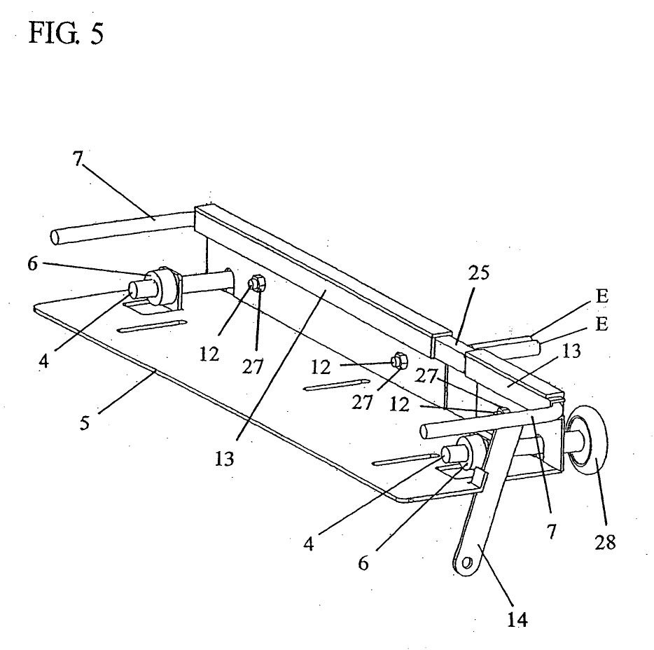

The latching means for the preferred embodiment also has a linkage means to connect each pair of joined release arms 7 one to the other for simultaneous operation. Component parts of this linkage means include latch arms 14 heretofore discussed, linkage arms 22 and an arm connector 23. FIG. 3 displays the linkage arms 22 and the arm connector 23 inside the toolbox 1. As shown, the arm connector 23 is rotatably mounted to the back panel 21 of the toolbox 1 by fastener 24. One end of the linkage arms 22 is slidably engaged with the integral shaft collar of the arm connector 23. A set screw, not shown, holds the linkage arms 22 to the arm connector 23 after installation. The other end of the linkage arms 22 rotatably connect each latch lever 14 one to the other. Next referring to FIG. 6, it can best be seen that in this configuration, and since the ends E of each pair of joined release arms 7 extend from the carriage assembly 5 and engage the slide stops 8 as heretofore described, that raising either release arm 7 on either carriage assembly 5 engages the latch arms 14, the linkage arms 22, and the arm connector 23 which in turn simultaneously raises the release arms 7 on the opposite carriage assembly 5 while lowering the ends E of each pair of release arms 7 that engage the slide stops 8. Conversely, lowering any release arm 7 on either carriage assembly 5 will simultaneously lower the release arms 7 on the opposite carriage assembly 5 while raising the ends E of each pair of release arms 7 that engage the slide stops 8. Thus, releasing or latching the toolbox 1 from the slide stops 8 along the drop rail 2 is achievable from either side of the pickup truck 45 from any one of four locations.

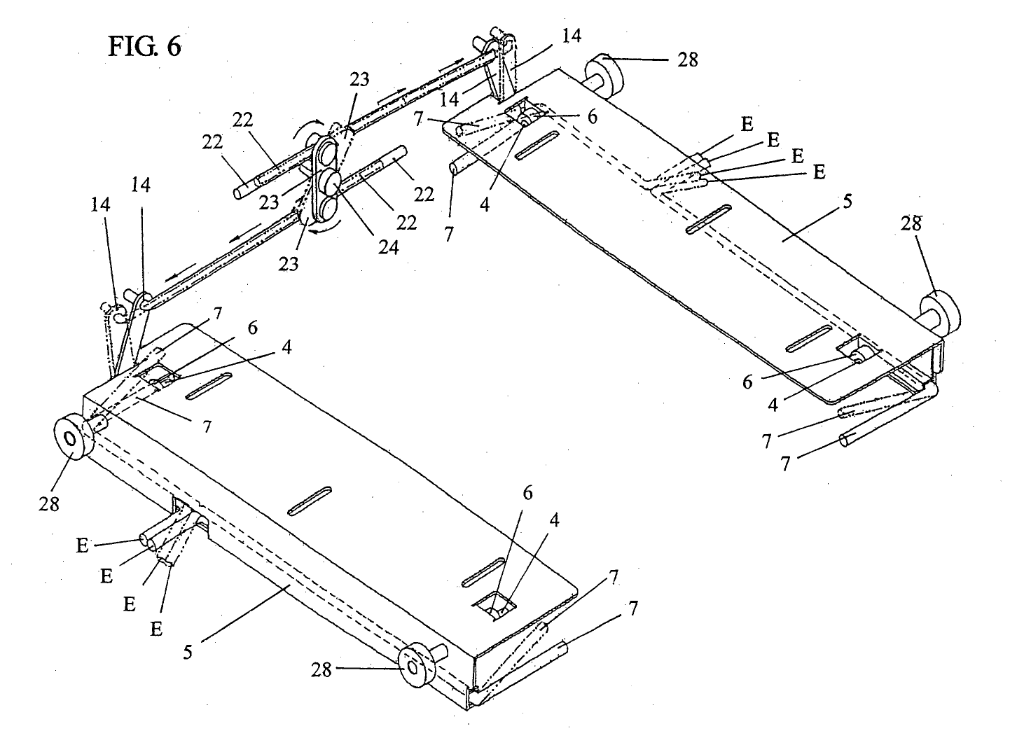

The slide stops 8 and drop rails 2 are displayed on FIGS. 7A through 7E. As shown on FIGS. 7A and 7B it can be seen that the slide stops 8 are fashioned to provide a positive stopping action for the toolbox 1 by capturing the ends E of the release arms 7 that are joined and extend from the carriage assembly 5 in their notched area as the toolbox 1 is slid along the drop rails 2. Next referring to FIGS. 7C and 7D, it can be seen that in the preferred embodiment, the slide stops 8 are positioned opposite one another along the drop rails 2 shown here to represent a close proximity to the front wall 42 and the rear tail gate wall 43 of the cargo area shown on FIG. 1. FIG. 7E displays the cross section of the drop rail 2 for the preferred embodiment with a slide stop 8 thereon.

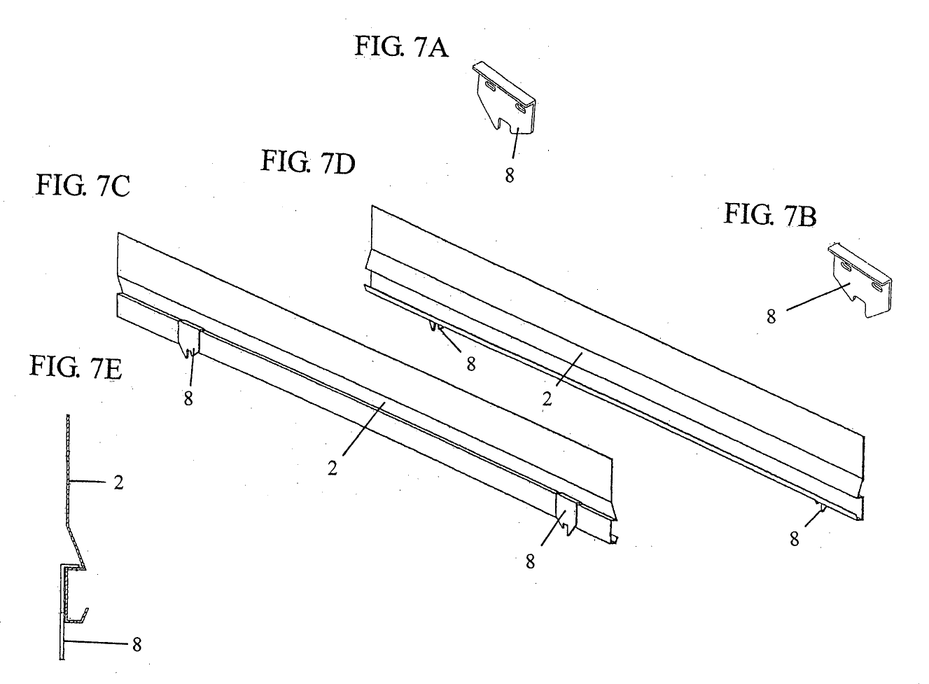

### FIG. 8—ALTERNATIVE EMBODIMENTS

There are various possibilities with regard to the cross sectional shape and configuration of the drop rail 2 shown on FIG. 7E and the release arms 7 shown on FIG. 4.

FIGS. 8A and 8B display an end view of the alternative embodiments for the drop rail 2. In the alternative embodiment shown on FIG. 8A the drop rail 2 has a top flange piece. In the alternative embodiment shown as FIG. 8B the bottom of the drop rail 2 track area is rounded. It should be understood that the alternative embodiments displayed are representative of the left drop rail 2, each right drop rail 2 being identical in size but opposite in shape.

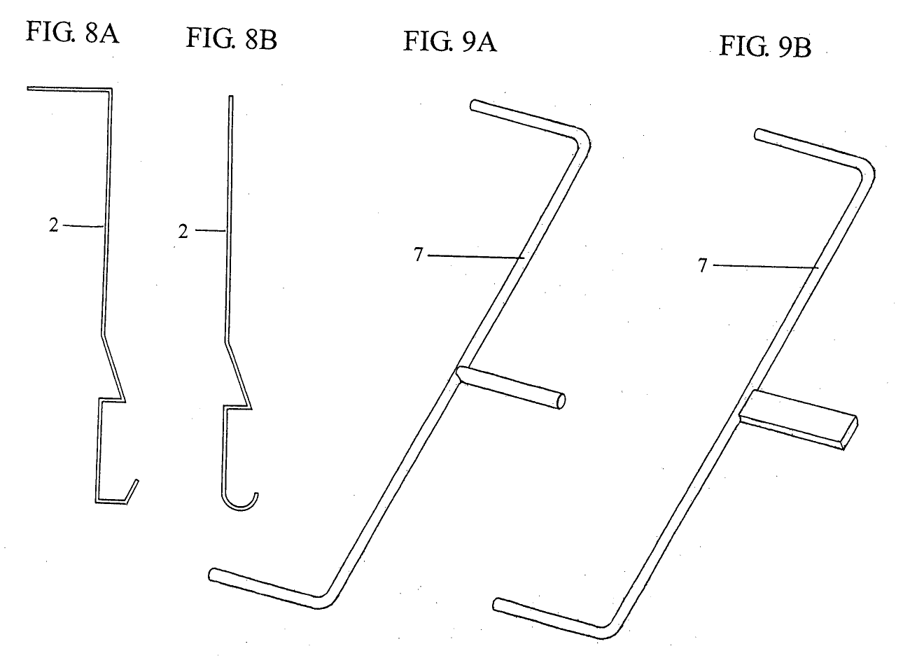

Next referring to FIGS. 9A and 9B it can be seen that the alternative embodiments of the release arm 7 are formed from a single piece of material As shown, these alternative embodiments use either a single piece of round stock or a single piece of flat stock respectively to engage the slide stops 8.

### ADVANTAGES

From the previous description, a number of advantages of our tool box conveyance system for a pickup truck become evident:
(a) The toolbox or drop rail does not encumber the top surface of the cargo area sidewalls thereby allowing the use of this working surface as well as the installation of aftermarket accessories such as stake bed type cab over storage racks and stake bed siding;
(b) The toolbox top lid is lockable to prevent pilfering of the toolbox contents;
(c) The top of the toolbox is positioned below the top surface of the cargo area sidewalls thus allowing maximum visibility through the rear window of the pickup truck cab; and allowing the use of cargo area covers;
(d) The handle for the release arm of the latching mechanism is operable from four locations and is accessible from either side of the truck so that operation from the traffic side of the truck is avoidable;
(e) A latching device that is sturdier than the related art is provided to lock the toolbox along the drop rail to prevent movement of the toolbox during operation of the pickup truck.

### OPERATION—FIGS. 1, 2, 3 AND 6

In operation, the toolbox 1 is supported by roller casters 4 that are slidably engaged with drop rails 2 and is stored in close proximity to the front wall 42 of the cargo area of a pickup truck 45. In the stored position the ends E of each pair of release arms 7 that are joined together and extend from the carriage assembly 5 are engaged with the slide stops 8 attached to the drop rails 2 to prevent movement of the toolbox 1 during operation of the pickup truck 45.

The toolbox 1 may be used when in the stored position. To gain access to the contents of the toolbox 1 the operator would unlock the locking device 16 and raise the top lid 17 to its open position with the handles 15. When finished, the operator would then lower the top lid 17 to its closed position with the handles 15 and then lock the top lid 17 with the locking device 16.

The toolbox 1 may also be moved from its stored position to the rear tailgate wall 43 of the cargo area. To release the toolbox 1 from its stored position the operator would raise either release arm 7 located at the front left or right bottom corner area of the toolbox 1. The release arm 7 is accessible from either side of the pickup truck 45. This operation disengages the ends E of the release arms 7 that extend from the carriage assembly 5 and engage the slide stops 8 along the drop rails 2. Both release arms 7 are accessible from either side of the pickup truck 45. Once released, the toolbox 1 is easily slidable along the drop rails 2 or it may be pulled by its handles 15. At the rear tailgate wall 43 the ends E of the release arms 7 that extend from the carriage assembly 5 will engage a set of slide stops 8 that will stop the toolbox 1 and latch it to the drop rail 2 to prevent its movement. The operator would then release the top lid 17 from its closed position through the operation of the locking device 16 and then raise the top lid 17 with the handles 15 to gain access to the contents of the toolbox 1.

When finished the operator would lower the top lid 17 with the handles 15 and then lock the top lid 17 in its closed position with the locking device 16. Return of the toolbox 1 to its stored position at the front wall 42 of the cargo area is similar to the actions required to move it to the rear tailgate wall 43 except that the operator would raise either release arm 7 located at the back left or back right bottom corner area of the toolbox 1. The release arms 7 are accessible from either side of the pick up truck 45. This operation will disengage the ends E of the release arms 7 that extend from the carriage assembly 5 from the slide stops 8. Once released, the toolbox 1 is easily slid along the drop rails 2 to its stored position at the front wall 42 of the cargo area where the ends E of the release arms 7 that extend from the carriage assembly 5 will engage the slide stops 8 to stop the toolbox 1 and latch it to the drop rail 2 to prevent its movement.

### CONCLUSION, RAMIFICATIONS, AND SCOPE

Accordingly, the reader will see that the toolbox conveyance system can provide lockable storage for a variety of items including, tools, parts, or supplies easily and conveniently, and just as easily and conveniently, allow access to these items when needed. Unlike related toolbox conveyance systems that use rails or channels directly attached to the cargo area sidewalls of a pickup truck to slide a toolbox along, the present toolbox conveyance system has the additional advantages in that the use of a drop rail:
Provides an unencumbered sidewall top surface for the installation of a camper shell and access to the stake sockets for the installation of cab over type storage racks or stake bed siding without alteration or removal of the installed toolbox conveyance system;
Positions the top of the toolbox below the top edge of the cargo area sidewalls thus providing maximum visibility through the rear window of the pickup truck cab and, for the use of cargo area covers.

Further, the latching mechanism of the toolbox conveyance system:
Is sturdier than related toolbox conveyance systems that use a single rod to secure each end of the tool box to prevent its movement along the rail or channel during operation of the pickup truck;
Enables the user to slide the toolbox to a stored position adjacent the cargo area front wall when loading or unloading bulk cargo or slide the toolbox to a position adjacent the cargo area rear tailgate wall to access its contents;
Provides the user with four locations from which the release arms can be operated from to release the toolbox from the slide stops and slide the toolbox along the drop rails;
Can be operated from either side of the pickup truck thereby providing safe operation from the curb side instead of a more dangerous traffic side.

Although the previous descriptions provided many specifications, it is to be understood that while certain forms of the present invention have been illustrated and described herein, it is not intended that these illustrations and descriptions be limited to the specific forms or arrangements of parts shown and described. Thus the scope of the invention should be determined by the appended claims and their legal equivalents, rather than by the examples.

We claim:

1. A conveyance system for the movement of a toolbox within the cargo area of a pickup truck said cargo area defined by a floor, a front wall, a rear tailgate wall, and opposite sidewalls said conveyance system comprising:
(a) A drop rail means detachably mounted in parallel relationship one to the other on opposite sidewalls of said cargo area and;
(b) A top lid, front panel, rear panel, left end panel, right end panel and bottom panel of predetermined size and shape to define a toolbox that is movable between said cargo area front wall and said cargo area rear tailgate wall and;
(c) A mounting means attached to said toolbox and slidably engaged with said drop rails and;
(d) A latching means movable between a lock position to prevent movement of said toolbox along said drop rails and a released position allowing movement of said toolbox along said drop rails.

2. A conveyance system for the movement of a toolbox within the cargo area of a pickup truck of claim 1 wherein
a drop rail means being comprised of a plurality of elongated rail members having a predetermined cross-sectional shape and size.

3. A conveyance system for the movement of a toolbox within the cargo area of a pickup truck of claim 1 said toolbox further including
a handle means said handle means attached to said toolbox top lid at predetermined locations.

4. A conveyance system for the movement of a toolbox within the cargo area of a pickup truck of claim 1 said toolbox further including
a locking means movable between a lock position to prevent movement of said toolbox top lid and a released position to allow movement of said toolbox top lid.

5. A conveyance system for the movement of a toolbox within the cargo area of a pickup truck of claim 1 said toolbox wherein
said toolbox top lid is movable between a closed position substantially covering said toolbox and an open position allowing access to said toolbox interior.

6. A conveyance system for the movement of a toolbox within the cargo area of a pickup truck of claim 1 said mounting means further including
a plurality of carriage assemblies said carriage assemblies having a predetermined cross sectional shape and size a respective one of said carriage assemblies attached to said toolbox left end panel and said toolbox right end panel.

7. A conveyance system for the movement of a toolbox within the cargo area of a pickup truck of claim 1 said mounting means further including
a plurality of roller casters a respective pair of said roller casters assembled to a respective one of said carriage assemblies the wheels of said roller casters engaged with said drop rails.

8. A conveyance system for the movement of a toolbox within the cargo area of a pickup truck of claim 1 a latching means further including
a plurality of slide stops a pair of which are attached along a respective one of said drop rails at predetermined locations.

9. A conveyance system for the movement of a toolbox within the cargo area of a pickup truck of claim 1 a latching means further including
a plurality of release arms and a means for joining said release arms said means for joining is welding.

10. A conveyance system for the movement of a toolbox within the cargo area of a pickup truck of claim 9 wherein
said joining means will join a respective pair of said release arms said release arms being rotatably mounted to the underside of a respective one of said carriage assemblies.

11. A conveyance system for the movement of a toolbox within the cargo area of a pickup truck of claim 10 wherein
the ends of each respective pair of joined release arms that extend from said carriage assembly and engage said slide stops are independent in operability and movable between a lock position to prevent movement of said toolbox along said drop rails and a release position to allow movement of said toolbox along said drop rails.

12. A conveyance system for the movement of a toolbox within the cargo area of a pickup truck of claim 1 a latching means further including
a means to cause simultaneous operation of each respective pair of said release arms on the underside of said carriage assemblies.

13. A conveyance system for the movement of a toolbox within the cargo area of a pickup truck of claim 12 wherein
a means to cause simultaneous operation of said release arms is comprised of a plurality of latch arms a plurality of linkage arms and a arm connector.

14. A conveyance system for the movement of a toolbox within the cargo area of a pickup truck of claim 13 wherein
a respective one of said latch arms is attached to each joined pair of said release arms said latch arms are connected one to the other by said linkage arms and said arm connector whereby said release arms are simultaneously operable and the ends of each pair of said release arms that extend from said carriage assemblies and are engaged with said slides stops are movable between a lock position to prevent movement of said toolbox along said drop rails and a release position to allow movement of said toolbox along said drop rails.
